(19) United States
(12) Patent Application Publication
(10) Pub. No.: US 2019/0242576 A1
(43) Pub. Date: Aug. 8, 2019

(54) FLUE GAS TREATMENT SYSTEM AND METHOD

(71) Applicant: CLEAN BIO HEAT SVERIGE AB, Stockholm (SE)

(72) Inventor: Thomas Gustafsson, Grillby (SE)

(21) Appl. No.: 16/326,877

(22) PCT Filed: Sep. 22, 2017
(86) PCT No.: PCT/SE2017/050920

§ 371 Date: Feb. 20, 2019

(30) Foreign Application Priority Data
Sep. 26, 2016 (SE) 1651264-2

(51) Int. Cl. F23J 15/06; B01D 53/14; F24H 8/00

(52) U.S. Cl. CPC F23J 15/06; B01D 53/1456; B01D 53/265; B01D 53/1412; F24H 8/00

(57) ABSTRACT

A system for simultaneous heat recovery and flue gas cleaning, comprising at least one heat pump (300), at least one combined heat recovery and flue gas cleaning unit (1) comprising a heat exchanger (10), said unit having an inlet (20) directing a flow of flue gas into said unit, an outlet (40) for allowing said flow of flue gas to leave said unit, wherein said heat pump is adapted to deliver a flow of cooling media to the heat exchanger at a temperature in the interval of about −4 to about +4° C. This system is compact, efficient and easy to operate. The system can easily be expanded thanks to a modular concept, and it is well suited for mobile applications. A method for heat recovery and flue gas cleaning is also disclosed.

### TECHNICAL FIELD

This disclosure relates generally to a system for simultaneous heat recovery and flue gas cleaning. The disclosure relates in particular to devices and methods to this end, and to systems incorporating such devices and implementing such methods.

### BACKGROUND

Humans have burned solid and liquid carbonaceous fuels to heat their dwellings since living in caves and simple huts. Starting from campfires, simple fire pits and rudimentary stoves, the heating arrangements have developed with time. Requirements of safety, convenience, fuel saving, and lately also environmental concerns, have driven the development towards more and more advanced heating arrangements.

The 20^{th} century saw the development and wide-spread use of central heating, arrangements comprising a burner, an accumulator tank, circulating hot water and radiators. Fossil fuels such as coal and oil became the most frequently used fuels. Today there is however a strong desire to substitute fossil fuels such as coal, oil and natural gas with renewable fuels such as plant based carbonaceous fuels, such as biogas, wood, straw and other biomass, such as fuel crops, and residue from agriculture and forestry. Municipal waste is also used as fuels, as well as industrial byproducts, mainly byproducts from the pulp and paper industry.

In order to not only clean the flue gases, but also to recover energy, different arrangements for the cooling of flue gases have been suggested. As flue gases frequently contain a considerable amount of water vapor, the cooling results in the formation of a condensate which also contains at least a portion of the chemical and particulate contaminants, such as water soluble sulfurous oxides and soot particles. Examples of such arrangements can be found in SE 501505 and SE 468651. In order to further purify the flue gas, these may be directed through a scrubber as described in EP 2 644 993.

LU 2012 0092073 discloses a method for processing gaseous fuel combustion gases, mainly where the gaseous fuel contains hydrogen, wherein the combustion gases (flue gases) are cooled and dried in a multi-step process.

SE 438 547 (EP 0013018) relates to a heating installation having a heating circuit and a heating furnace, in particular oil or gas fired. This installation includes an exhaust flue in which there is arranged in heat-exchange relationship the evaporator of a heat pump in which circulates a refrigerant, where the said evaporator may with assistance from a blower be acted upon at option by flue gas, by a mixture of flue gas and outside air, or by outside air, and the condenser of the said heat pump lies in heat-exchange relationship in the heating circuit, characterized in that a control apparatus is provided, which with the blower running switches on the heating furnace in dependence upon the pressure (or the temperature) of the refrigerant in the evaporator and upon the pressure (or the temperature) falling below a predetermined lower limiting value, and switches off the said furnace upon a predetermined limiting value of the pressure (or the temperature) being exceeded.

Even though various arrangements directed to improved efficiency and reduced emissions have been disclosed in the above cited documents and others, there is still a need for further improvements.

### SUMMARY

According to a first aspect, this disclosure makes available a system for simultaneous heat recovery and flue gas cleaning, comprising
at least one combined heat recovery and flue gas cleaning unit comprising a heat exchanger, said unit having an inlet directing a flow of flue gas into said unit, an outlet for allowing said flow of flue gas to leave said unit,
at least one heat pump adapted to deliver a flow of cooling media to the heat exchanger at a temperature in the interval of about −4 to about +4° C.; and
a control unit for said system,
   wherein said control unit is adapted to measure the flow of the flue gas and the temperature of the cooling medium, to control the operation of said system to maintain an input temperature of the cooling medium in the interval of about −4 to about +4° C. when a sufficient flue gas flow rate is detected, and to interrupt the flow of cooling media or to allow the temperature of cooling media to raise to above 0° C. when the flow rate is below a pre-set value.

There are different ways to control the heat pump, for example by regulating the speed of the compressor or the flow of the cooling medium. When the heat pump is connected to an energy consumer, for example circulating air or water used to heat a building, the circulation of this secondary heat medium can be regulated, either increasing or decreasing the output.

According to an embodiment of said first aspect, said control unit is adapted to measure the flow and temperature of the flue gas, and to control the operation of said unit to maintain an exit temperature of the flue gas of less than about 40° C., preferably less than about 30° C., most preferably about 20° C. or less.

According to a preferred embodiment of said first aspect said at least one inlet and said outlet are positioned on opposite sides of said heat exchanger in the direction of the flow of flue gas; said at least one inlet and said outlet are offset in height; said unit comprises a condensate drain; and said unit has a substantially rhomboid vertical cross section.

According to an embodiment, freely combinable with the above, said first inlet is located in an upper section of said rhomboid shaped unit, said heat exchanger is located in a middle section; and said flue gas outlet and condensate drain are located in a lower section; and said drain being located at the lowest point of said rhomboid shaped unit.

Preferably said condensate drain is located at a distance from said flue gas outlet which is equal to or larger than the diameter of said outlet.

According to an embodiment, freely combinable with the above, the system further comprises a fan positioned in a flue gas duct down-stream of the flue gas outlet.

According to yet another embodiment, freely combinable with the above embodiments, at last one plate or baffle is arranged in the flow path of the flue gas after entering the unit through the inlet and before entering the heat exchanger, said plate or baffle distributing the flue gas evenly over the heat exchanger.

According to a further embodiment, the heat exchanger is connected to a heat pump which supplies a cooling medium to said heat exchanger and collects heat from the flue gas and delivers said heat to a secondary heat consumer.

Preferably said heat pump and heat exchanger are adapted to cool the flue gas to a temperature of about 40° C. or below. More preferably, the system is adapted for cooling the flue gas to a temperature of about 30° C. or below, more preferably about 20° C., and most preferably during a single pass through the heat exchanger.

According to a further embodiment, freely combinable with any of the above aspects and embodiments, said combined heat recovery and flue gas cleaning unit comprises at least two heat exchangers connected in series.

According to another embodiment, said system comprises at least two combined heat recovery and flue gas cleaning units connected in parallel.

According to one aspect of this disclosure, said system is adapted for integration with a boiler, preferably a boiler operating on a fuel chosen from natural gas, biogas, diesel, pellets, wood chips, biofuel, forest residue, lignocellulosic waste, recycled construction material and recycled wood, fuel crops, agriculture residue, forestry residue and mixtures thereof.

According to an embodiment of the above aspect, the system is assembled or built into in a mobile module, preferably a shipping container.

Another aspect of this disclosure relates to a method for operating a system for simultaneous heat recovery and flue gas cleaning according to the first aspect or any one of the embodiments thereof in a heating arrangement comprising a boiler, a control unit, a primary circuit heated by said boiler, and a secondary circuit heated by flue gases from said boiler, a heat pump and at least one heat exchanger through which the flue gas passes, wherein said heat pump in said secondary circuit supplies cooling medium to said heat exchanger at a temperature in the interval of about −4 to about +4° C., and said control unit measures the flow of the flue gas and the temperature of the cooling medium, controlling the operation of said system to maintain an input temperature of the cooling medium in the interval of about −4 to about +4° C. when flue gas flow rate above a pre-set value is detected, and wherein said control unit interrupts the flow of cooling media or allows the temperature of cooling media to raise to above 0° C. when the flow rate is below said pre-set value.

According to another embodiment freely combinable with the above, the operation of said secondary circuit, heat pump and heat exchanger is controlled to maintain an exit temperature of the flue gas of less than about 40° C., preferably less than about 30° C., most preferably about 20° C. or less.

According to a further embodiment, the flow and temperature of the flue gas is measured, and the operation of said secondary circuit, heat pump and heat exchanger is controlled to remove substantially all or at least a significant portion of the particulate matter from the flue gas, concentrating said particulate matter in the condensate.

As an example, the operation of said secondary circuit, heat pump and heat exchanger is preferably controlled so as to produce at least 5 liters of condensate per 100 kWh heat produced by the fuel in the burner, preferably at least 8 liters of condensate/100 kWh.

According to an embodiment of the method, said secondary circuit supplies heat to an external consumer, for example a fan coil unit, a convector heater, a radiator, a building dryer.

According to an embodiment of the method, freely combinable with all the above embodiments, said boiler operates on a carbonaceous fuel chosen from biogas, natural gas, diesel, pellets, wood chips, biofuel, forest residue, lignocellulosic waste, recycled construction material and recycled wood, fuel crops, agriculture residue, forestry residue and mixtures thereof.

The above and other aspects and embodiments, as well as their features and advantages, will become apparent from the following description read in conjunction with the accompanying drawings, in which like reference numerals designate the same elements.

### BRIEF DESCRIPTION OF THE DRAWINGS

For a more complete understanding of the disclosed devices and methods, reference is now made to the accompanying drawings in which:

FIG. 1 shows a schematic overview of a system which comprises a combined heat recovery and flue gas cleaning unit (1);

FIG. 2 shows a schematic overview of a combined heat recovery and flue gas cleaning unit (2);

FIG. 3 shows a schematic overview of a combined heat recovery and flue gas cleaning unit (3) comprising several heat exchangers in series;

FIG. 4 shows a schematic overview of two combined heat recovery and flue gas cleaning units (4′, 4″) connected in parallel;

FIG. 5 schematically shows four alternative configurations of the combined heat recovery and flue gas treatment unit;

FIG. 6 is a graph showing the performance of the system according to embodiments of this disclosure during a two hour test run. The curves represent the flue gas temperature before (A) and after (B) passing through a combined heat recovery and flue gas cleaning unit.

FIG. 7 is a graph showing the performance of a unit according to embodiments disclosed herein, during the same two hour test run. The upper curve (C) represents the output of the system, and the lower curve (D) represents the energy consumption of the system, indicating that a COP above 6 could be reliably achieved.

The drawings are not intended to limit the scope which is set out in the claims, but merely to clarify and exemplify the aspects and embodiments disclosed herein.

### DESCRIPTION

Before the present invention is described, it is to be understood that the terminology employed herein is used for the purpose of describing particular embodiments only and is not intended to be limiting, since the scope of the invention will be limited only by the appended claims and equivalents thereof.

It must be noted that, as used in this specification and appended claims, the singular forms “a”, “an” and “the” also include plural referents unless the context clearly dictates otherwise.

The present inventor noted the lack of efficient, compact and reliable systems for combined heat recovery and flue gas cleaning. He observed that many of the prior art systems involved scrubbing, i.e. the introduction of water into the flue gases. It was also apparent to the inventor that the efficacy of the prior art systems, measured as the coefficient of performance (COP), often was less than satisfactory. He therefore set out to improve the construction, control and design of such systems.

Consequently, according to a first aspect, this disclosure makes available a system for simultaneous heat recovery and flue gas cleaning, comprising
at least one combined heat recovery and flue gas cleaning unit (1) comprising a heat exchanger (10), said unit (1) having an inlet (20) directing a flow of flue gas into said unit (1), an outlet (40) for allowing said flow of flue gas to leave said unit (1),
at least one heat pump (300) adapted to deliver a flow of cooling media to the heat exchanger (10) at a temperature in the interval of about −4 to about +4° C.; and
a control unit for said system,
   wherein said control unit is adapted to measure the flow of the flue gas and the temperature of the cooling medium, to control the operation of said system to maintain an input temperature of the cooling medium in the interval of about −4 to about +4° C. when a sufficient flue gas flow rate is detected, and to interrupt the flow of cooling media or to allow the temperature of cooling media to raise to above 0° C. when the flow rate is below a pre-set value. The terms “sufficient flow” and “pre-set value” refers to parameters which will be clear to a person skilled in the art, but which may vary between different installations, due to differences in size, the diameter and cross-section area of ducts, etc.

According to an embodiment of said system, said at least one inlet and said outlet are positioned on opposite sides of said heat exchanger in the direction of the flow of flue gas; said at least one inlet and said outlet are offset in height; said unit comprises a condensate drain; and said unit has a substantially rhomboid vertical cross section.

According to an embodiment of said system, said first inlet is located in an upper section of said rhomboid shaped unit, said heat exchanger is located in a middle section, said flue gas outlet and condensate drain are located in a lower section; and said drain is located at the lowest point of said rhomboid shaped unit.

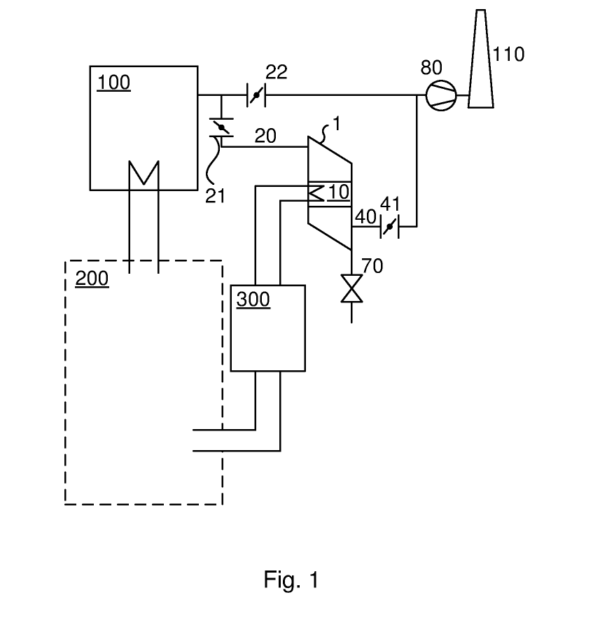

An example is schematically shown in FIG. 1, where a combined heat recovery and flue gas cleaning unit (1) is connected to a boiler (100) and a secondary heat consumer (200) via a heat pump (300) in such a fashion that remaining heat in the flue gas can be recovered, at the same time as the flue gas is cleaned. Flue gas exiting the boiler (100) is either led directly to a smoke stack (110) or led into a combined heat recovery and flue gas cleaning unit (1) via an inlet (20). Cooled and cleaned flue gas exists the unit (1) via an outlet (40) and it released through the smoke stack (110). A flue gas fan (80) may be provided. Condensate containing a significant portion of the particulate matter, soot etc., is removed through a drain (70). Dampers (21, 22, 41) are used to control the fraction of flue gas passing through the unit (1).

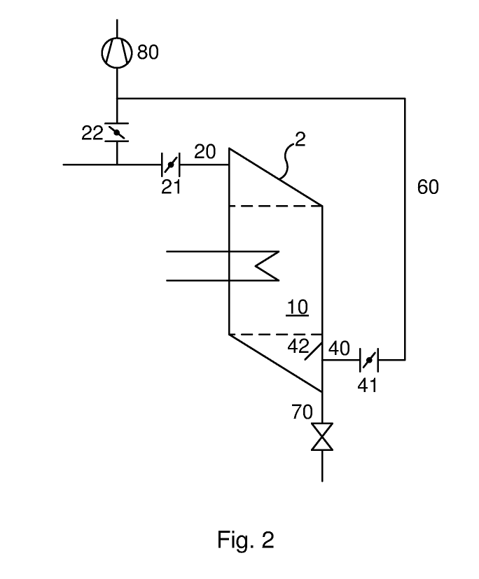

FIG. 2 schematically illustrates an embodiment where a combined heat recovery and flue gas cleaning unit (2) is connected to a flue gas pipe via an inlet (20). Dampers (21, 22) can be provided to direct all, or a fraction, of the flue gas into said unit (2). When for example the first damper (21) is closed and the second damper (22) is open, the entire flue gas flow will pass directly to the ambient, possibly via a smoke stack (not shown) or flue gas pipe. The flue gas pipe preferably includes a flue gas fan (80). The combined heat recovery and flue gas cleaning unit (2) houses a heat exchanger (10). Flue gas that has passed the heat exchanger (10) exits the unit (2) through an outlet (40) positioned in the lower part of the unit. In front of the outlet (40) a plate (42) can optionally be placed, preventing condensate from being pulled into the outlet. The unit is designed so, that condensate collects at the lowest point of the unit, where it can be removed through a drain (70). Optionally, an additional damper (41) is arranged at a suitable position in the pipe or duct (60).

According to an embodiment freely combinable with any of the above, said condensate drain is located at a distance from said flue gas outlet which is equal to or larger than the diameter of said outlet. The diameter of the flue gas outlet is preferably about 150 mm, about 200 mm or about 250 mm but can also be of a larger or smaller diameter, depending on the capacity of the boiler.

According to an embodiment freely combinable with any of the above, said system further comprises a fan (80) positioned in a flue-gas duct down-stream of the flue gas outlet (40). When a system according to any of the embodiments disclosed herein is integrated into an existing system, there is likely to be an existing flue gas fan located between the boiler and the smoke stack. The current system is then preferably integrated in such fashion that the existing fan can be used.

According to yet another embodiment, freely combinable with the above embodiments, at last one plate or baffle (42) is arranged in the flow path of the flue gas after entering the unit through the inlet and before entering the heat exchanger, said plate or baffle distributing the flue gas evenly over the heat exchanger. This is preferably a plate or baffle creating turbulent flow, possibly in combination with plates or baffles guiding the flue gas.

According to a further embodiment, the heat exchanger is connected to a heat pump which supplies a cooling medium to said heat exchanger and collects heat from the flue gas and delivers said heat to a secondary heat consumer. Preferably said heat pump and heat exchanger are adapted to cool the flue gas to a temperature of about 40° C. or below, preferably about 30° C. or below, most preferably about 20° C. or below.

Said secondary heat consumer can be circulating hot water or hot air for warming, and it can comprise a second heat exchanger, or an external consumer, for example a fan coil unit, a convector heater, a radiator, a building dryer etc.

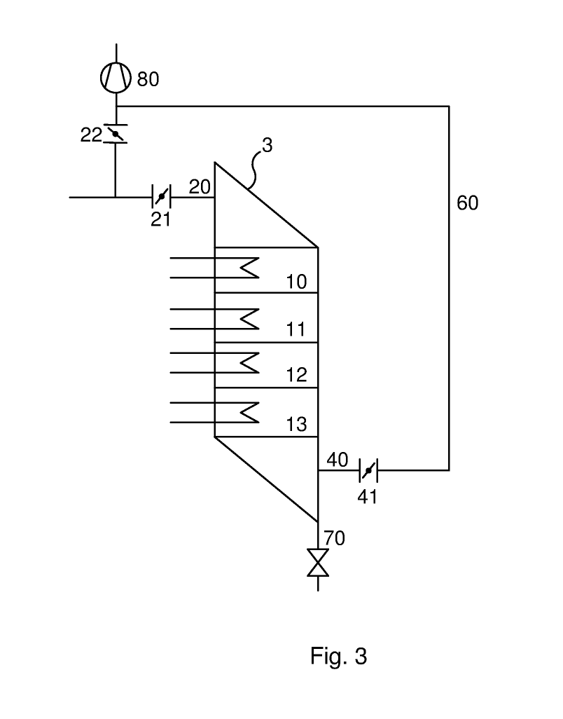

According to a further embodiment, said combined heat recovery and flue gas cleaning unit comprises at least two heat exchangers connected in series. This is illustrated in FIG. 3, where a combined heat recovery and flue gas cleaning unit (3) comprises a total of four heat exchangers (10, 11, 12 and 13). It is currently contemplated that two heat exchangers are sufficient, as a higher number of heat exchangers will lead to increased resistance and lower flue gas flow. The exact configuration can be adapted by a person skilled in the art.

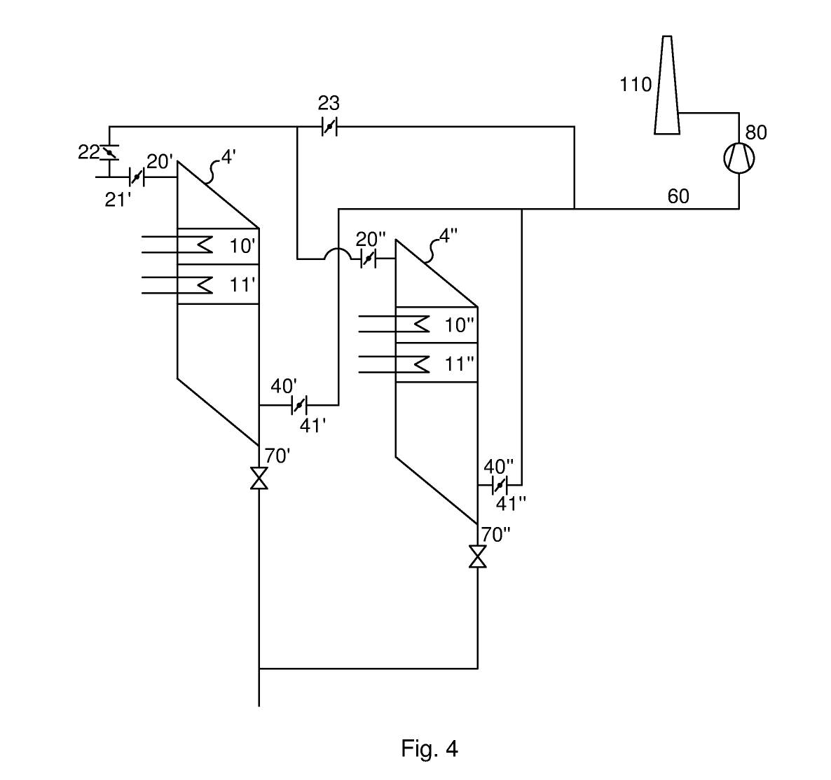

According to another embodiment, said system comprises at least two combined heat recovery and flue gas cleaning units connected in parallel. This is schematically illustrated in FIG. 4, where two combined heat recovery and flue gas cleaning units (4′ and 4″) are connected in parallel. Each unit (4′ and 4″) is shown as holding two heat exchangers (10′, 11′ and 10″, 11″, respectively). This modular construction makes it convenient to adapt the system to different end-users, for example burners with different power. The system is shown with a similar arrangement as in FIGS. 1 and 2, mutatis mutandis. One difference is for example the presence of an additional damper (23) which when open, makes it possible to bypass the second unit (4″).

According to one aspect of this disclosure, said system is adapted for integration with a boiler, most preferably a boiler operating on a fuel chosen from biogas and biomass, such as pellets, wood chips, scrap wood, and forest residue.

According to an embodiment of the above aspect, the system is assembled in a mobile module, preferably a shipping container. This mobile module preferably has external couplings or connections for rapidly connecting it to the flue gas duct exiting a burner, and for connecting incoming and outgoing heat and cooling medium and the like.

According to an embodiment, freely combinable with the above aspects and embodiments, the system comprises a control unit, wherein said control unit measures the flow and temperature of the flue gas, and controls the operation of said unit to maintain an exit temperature of the flue gas of about 20° C. or below.

Another aspect of this disclosure relates to a method for operating a system for simultaneous heat recovery and flue gas cleaning according to any one of claims 1-14 in a heating arrangement comprising a boiler, a control unit, a primary circuit heated by said boiler, and a secondary circuit heated by flue gases from said boiler, a heat pump and at least one heat exchanger through which the flue gas passes, wherein said heat pump in said secondary circuit supplies cooling medium to said heat exchanger at a temperature in the interval −4 to +4° C., and said control unit measures the flow of the flue gas and the temperature of the cooling medium, controlling the operation of said system to maintain an input temperature of the cooling medium in the interval of −4 to +4° C. when flue gas flow rate above a pre-set value is detected, and wherein said control unit interrupts the flow of cooling media or allows the temperature of cooling media to raise to above 0° C. when the flow rate is below said pre-set value.

According to an embodiment of the above method, the operation of said secondary circuit, heat pump and heat exchanger is controlled to maintain an exit temperature of the flue gas of about 20° C. or below.

According to a further embodiment, the flow and temperature of the flue gas is measured, and the operation of said secondary circuit, heat pump and heat exchanger can for example be controlled so as to produce at least about 5 liters of condensate per 100 kWh heat produced by the fuel in the burner, preferably at least about 8 liters of condensate/100 kWh.

According to yet another embodiment, freely combinable with the above, the flow and temperature of the flue gas is measured, and the operation of said secondary circuit, heat pump and heat exchanger is controlled to remove substantially all or at least a significant part of particulate matter, for example at least 95%, from the flue gas, concentrating said particulate matter in the condensate.

According to an embodiment of the method, said secondary circuit supplies heat to an external consumer, for example a fan coil unit, a convector heater, a radiator, a building dryer etc.

According to an embodiment of the method, freely combinable with all the above embodiments, said boiler operates on a carbonaceous fuel chosen from biogas, natural gas, diesel, pellets, wood chips, biofuel, forest residue, lignocellulosic waste, recycled construction material and recycled wood, fuel crops, agriculture residue, forestry residue, and mixtures thereof.

A system according to aspects and embodiments disclosed herein is preferably a modular system, adapted for integrating into a new boiler arrangement at the time of construction, or adapted for retro-fitting into an existing boiler arrangement, adapted for connecting to an existing stationary or mobile boiler arrangement.

The system preferably comprises adapters for connecting said flue gas treatment unit and control unit to a boiler, said adapters leading flue gas from said boiler into said flue gas treatment unit. Most preferably said system intersects the existing flue gas pipe so that the flue gas—after heat recovery and cleaning—can be released through an existing smoke stack or flue pipe.

FIG. 1 shows an embodiment where a boiler (100) supplies heat to a consumer (200). Flue gas from the boiler (100) is drawn by a fan (80) and released through a smoke stack or flue pipe (110). A system according to embodiments presented herein is connected to the flue gas pipe via a flue gas inlet (20) guiding hot flue gas into a combined heat recovery and flue gas cleaning unit (1). An advantage of the system and method is that the flue gas will be less humid and much less corrosive to the smoke stack or flue pipe.

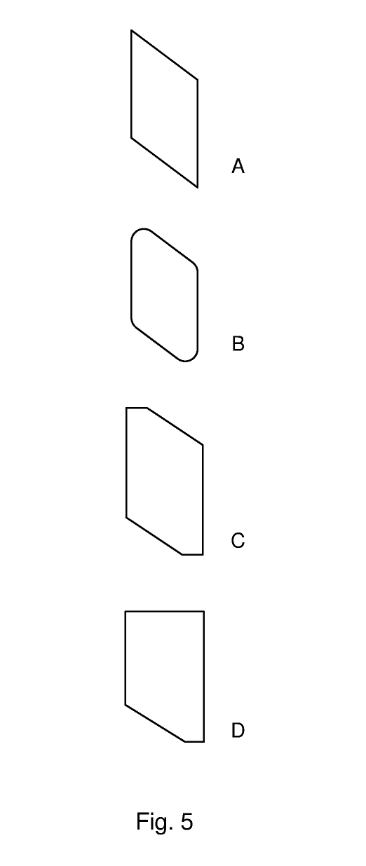

Preferably the shape of the unit (1) is substantially rhomboid, when seen in vertical cross-section. The drawings are not to scale, and only indicate the configuration of the unit. The corners of the unit may for example be rounded, and the flue gas ducts can be led differently, and are preferably given rounded bends and adapted to minimize flow resistance, as well known to a skilled person. Different configurations are shown in FIG. 5 A-D. which shows four alternative configurations of the flue treatment unit, starting from the rhomboid shape with sharp corners (A), a rhomboid shape with rounded corners (B), a rhomboid shape with truncated corners (C), and a shape with a substantially flat upper part and truncated lower corner (D).

Variants and combinations of these shapes are also possible. Current experience indicates that the truncated rhomboid shape shown in FIG. 5 C performs very well. This has been confirmed in practical field tests, measuring the temperature on the surface of the unit, looking for possible localized hot or cold areas. The inventor has also commissioned computer simulations of the flow pattern and temperature distribution, and the results confirm the utility of the shape shown in FIG. 5 C. This shape has additional advantages in that it requires only limited space and can easily be installed in existing systems.

In a system as that schematically shown in FIG. 1, the hot flue gas comes from the boiler through a channel or duct leading to an inlet (20) in the upper part of the unit (1). Valves or dampers (21, 22) are present to divide the flue gas between the original flue gas pipe and the combined heat recovery and flue gas cleaning unit. The valves or dampers can be open, partially open or closed, leading a fraction or all of the flue gas to the combined heat recovery and flue gas cleaning unit.

The system comprises a first circuit or heat consumer, for example circulating hot water, heated by the burner, and a second circuit, for example a cooling medium supplied by a heat pump and heated in the heat exchanger (10) and which then either serves to pre-heat the hot water in said first circuit (200) or which serves an external heat consumer, e.g. a fan coil unit, a convector heater, a radiator, a building dryer, circulating hot water, circulating warm air etc. Examples of such heaters include, but are not limited to the El-Björn range of TVS heaters and TF heaters (El-Björn AB, Anderstorp, Sweden).

A plate may optionally be placed in the upper part of the unit to create turbulence (not shown). A heat exchanger (10) is inserted in the unit (1), preferably removably inserted allowing inspection and cleaning of the heat exchanger.

The lower part of the unit (1) has an outlet (40) leading into a duct having a second damper (41). By adjusting the position of the dampers, the portion of flue gas passing through the heat exchanger (10) can be adjusted between 0 and 100%. Preferably 100% of the flue gas is forced to pass through the heat exchanger (10) during normal operation, but it is conceivable that another setting is used during start-up and shut-down of the system. During start-up, it may be advantageous to be able to successively increase the portion of flue gas that is led through the heat exchanger (10) until the system is balanced and fully operational.

In the lower part of unit (1), a condensate outlet or drain (70) is located. The condensate drain (70) is preferably located in the lowest part of the unit, allowing total emptying of condensate collected therein. The condensate drain (70) may comprise a valve. In normal operation, said valve is preferably open and the condensate led to the drain or collected for further purification. An advantage of the condensate collection is that impurities present in the flue gas are concentrated at one point, where they can be taken care of, instead of diluted and spread with the wind as is the case without any flue gas cleaning.

The second outlet (40) is preferably positioned at a distance from the lowest point of the unit (1) eliminating or at least minimizing carry-over of condensate into the outgoing cooled flue gas. Optionally, a plate or baffle (42) is arranged in the lower part of the unit (1) further eliminating or at least minimizing carry-over of condensate into the outgoing cooled flue gas. This embodiment is schematically shown in FIG. 2. Other arrangements for trapping condensate droplets can be implemented, for example a series of baffles creating a tortuous path for the outgoing flue gas.

FIG. 2 schematically shows a combined heat recovery and flue gas cleaning unit (2). By adjusting the positions of the dampers (21, 22) a fraction of the flue gas, or preferably the entire flue gas flow is lead into the combined heat recovery and flue gas cleaning unit (2) and forced to pass a heat exchanger (10). The outgoing flue gas is then led to the smoke stack (not shown) through duct (40). Preferably a fan (80) is arranged in the duct (60). FIG. 2 also illustrates how the inlet (20) and outlet (40) are positioned on opposite sides of the unit, and offset in height, forcing the flue gas to pass evenly through the heat exchanger.

FIG. 3 illustrates how a combined heat recovery and flue gas cleaning unit (3) is adapted for holding more than one heat exchanger, here illustrated by four heat exchangers (10, 11, 12, and 13) in series.

Test runs conducted with a full scale prototype have shown that a device and method as disclosed herein has many advantages. The overall efficiency of the boiler is significantly improved, as heat is recovered from the flue gas. As a result, the fuel economy is improved, as more heat is generated by the same amount of fuel. This is advantageous both from an economical point of view, and also considering the impact on the environment, as less fuel is consumed, and smaller volumes needs to be processed, handled and transported to the burner.

One advantage of the embodiments disclosed herein is that the cooling is very fast and efficient, and the condensate formed can be collected. The flue gases can therefore be efficiently cleaned without the use of any filter, cyclone or other conventional equipment which frequently needs maintenance. Further, the cleaning is achieved without scrubbing, a method frequently used. Scrubbing, which involves the injection of water into the flue gas significantly increases the amount of water that needs to be taken care of.

In fact, tests performed by the present inventor have shown that particulate matter (mainly soot) is effectively removed from the flue gas. Further, water soluble contaminants are concentrated in the condensate. Examples of water soluble contaminants are corrosive gases such as hydrochloric acid and ammonia. It is expected that also other contaminants, such as sulfurous oxides (SOx) and nitrous oxides (NOx) are at least partially collected in the condensate. Possibly also the emissions of organic contaminants, such as total hydrocarbons (THC), polyaromatic hydrocarbons (PAH), and heavy metals, such as cadmium, mercury etc. can be reduced. Further tests will be conducted to investigate this. An initial analysis of the condensate however indicates this.

This makes it possible to separate contaminants already at the source, instead of these being distributed with the flue gas. Depending on the fuel used in the burner, this concentrate can be drained to the municipal waste water, or collected for later treatment. Such later treatment can be neutralization, sedimentation, ion exchange etc., all methods well known to persons skilled in the art.

The separation of a condensate also significantly reduces the moisture content. As the moisture content of the flue gas is reduced, the risk of corrosion in the ducts and smoke stack is reduced. The removal of water soluble corrosive substances, such as hydrochloric acid, further extends the life span of ducts and smoke stack.

An additional advantage is that a device as disclosed herein is easily scalable and can be adapted to burners of different size (different power). As shown schematically in FIGS. 3 and 4, there are mainly two principles of expanding the arrangement. As shown in FIG. 3, one device can include from one to four heat exchangers, connected in series in relation to the flow of flue gas. Additionally, as shown in FIG. 4, several devices can be connected in parallel. It is currently conceived that the smallest arrangement would include one combined heat recovery and flue gas cleaning unit having one heat exchanger installed. A medium size arrangement would include one unit having two to four heat exchangers, or even two units in parallel, each having two to four heat exchangers. Correspondingly, a large installation could for example include four units, each having two to four heat exchangers.

The modular construction gives additional advantages, in that an existing installation can be easily expanded. An arrangement can also be realized such, that parallel devices make it possible to vary the effect or to disconnect and by-pass portions of the arrangement for cleaning and maintenance when necessary.

General advantages of the embodiments, in addition to those outlined above, include that the arrangement can be made compact and mobile. In a preferred embodiment, the system is assembled in or built into a shipping container. This makes the system easy to transport and to place at a desired location, as a free-standing unit, connected to the flue gas pipe. Preferably said container or mobile unit ha external couplings or connections, facilitating connection to in- and outgoing heart medium an the like.

A system as disclosed herein is also easy to operate and to maintain.

### EXAMPLES

### Example 1. The System Exhibits Stable Performance and a High COP

The inventor assembled a pilot scale to full scale test unit, comprising a closed control unit (CCU, from SCMREF AB, Vislanda, Sweden) for precision cooling using a liquid heat transfer medium, a cross flow heat exchanger (Airec Cross 30, from AIREC AB, Malmo, Sweden), electrically controlled dampers, a continuously adjustable flue gas fan, pressure and temperature sensors, and control electronics.

The heat exchanger was modified by the inventor and fitted into a mobile heat recovery and flue gas treatment unit as disclosed herein. A standard 8×8 foot (2.43×2.43 m) shipping container was used to house all equipment.

The CCU was connected to an expansion vessel, and connected in a closed circulation to the heat exchanger. The CCU supplied cooling medium holding a temperature in the interval of −4 to +4° C. to said heat exchanger. The out-put from the CCU was led to two hot water fan heaters (Model TF 50HWI from El-Björn AB, Anderstorp, Sweden) placed outdoors.

This flue gas treatment unit was placed next to a standard 450 kW mobile burner, designed to supply hot air for heating, e.g. for the heating of constructions sites, sports arenas and other large spaces. The inventor fitted a T-connection to the flue gas duct, and the flue gas was led into the flue gas treatment unit as disclosed herein.

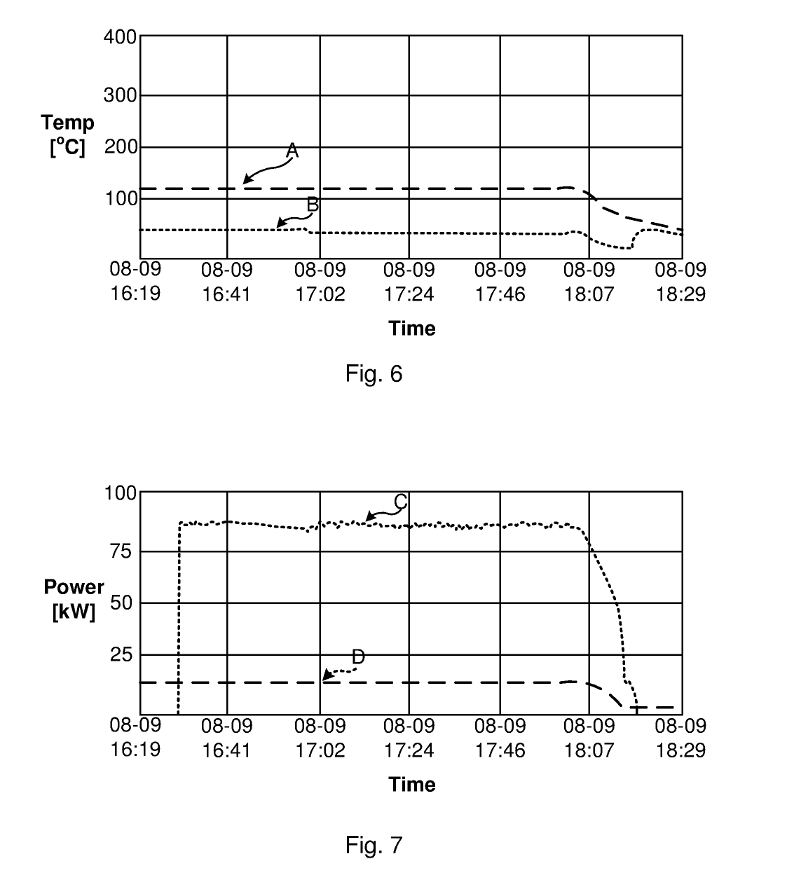

The flue gas had a temperature of about 120° C. During different test runs, the flue gas treatment unit cooled the flue gas to a temperature of 20-40° C. In the test run reflected in the figures, FIG. 6 and FIG. 7, the system was run at full effect, with an incoming flue gas temperature (A) of about 118° C. in average, and an outgoing flue gas temperature (B) of about 43° C. in average. In other experiments, even lower outgoing flue gas temperatures were achieved and kept stable. As can be seen in FIG. 6, the system performed well and was stable during the entire two hour test run.

FIG. 7 shows the output (kW) produced by the system (curve C) compared to the power consumed by the system (D). The results show that the system produced a stable output of about 85 kW while it consumed only 13 kW, resulting in a COP of 6.5. This is a surprisingly high COP, as heat pumps typically have a COP in the range 2 to 4. In other experiments, even higher COP values have been recorded.

### Example 2. Particulate Matter is Efficiently Removed from the Flue Gas

In order to test the flue gas cleaning capacity, the inventor placed a filter paper in the flue gas pipe, collecting particulate matter or soot contained in the flue gas. The filter paper was weighed before and after, giving a numerical value of the soot content during different operating conditions. The flue gas was then led through the combined heat recovery and flue gas cleaning unit, and a clean filter paper was placed in the flue gas pipe in the same position and for the same length of time. These measurements indicated that on average at least 95 weight-% of the particulate matter was removed by the combined heat recovery and flue gas cleaning unit, and collected in the condensate.

A sample of the condensate, obtained when the boiler was operated on pellets, was sent for analysis. The analysis results indicate that the condensate can be released into the municipal waste water system.

Without further elaboration, it is believed that a person skilled in the art can, using the present description, including the examples, utilize the present invention to its fullest extent. Also, although the invention has been described herein with regard to its preferred embodiments, which constitute the best mode presently known to the inventors, it should be understood that various changes and modifications as would be obvious to one having the ordinary skill in this art may be made without departing from the scope of the invention which is set forth in the claims appended hereto.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A system for simultaneous heat recovery and flue gas cleaning, comprising
at least one combined heat recovery and flue gas cleaning unit (1) comprising a heat exchanger (10), said unit (1) having an inlet (20) directing a flow of flue gas into said unit (1), an outlet (40) for allowing said flow of flue gas to leave said unit (1),
at least one heat pump (300) adapted to deliver a flow of cooling media to the heat exchanger (10) at a temperature in the interval of −4 to +4° C.; and
a control unit for said system,
wherein said control unit is adapted to measure the flow of the flue gas and the temperature of the cooling medium, to control the operation of said system to maintain an input temperature of the cooling medium in the interval of −4 to +4° C. when a sufficient flue gas flow rate is detected, and to interrupt the flow of cooling media or to allow the temperature of cooling media to raise to above 0° C. when the flow rate is below a pre-set value.

2. The system according to claim 1, wherein said control unit is adapted to measure the flow and temperature of the flue gas, and to control the operation of said unit to maintain an exit temperature of the flue gas of less than 40° C., preferably less than 30° C., most preferably 20° C. or less.

3. The system according to claim 1, wherein said at least one inlet (20) and said outlet (40) are positioned on opposite sides of said heat exchanger (10) in the direction of the flow of flue gas; said at least one inlet (20) and said outlet (40) are offset in height; said unit (1) comprises a condensate drain (70); and said unit (1) has a substantially rhomboid cross section.

4. The system according to claim 3, wherein said first inlet (20) is located in an upper section of said rhomboid shaped unit (1), said heat exchanger (10) is located in a middle section; and said flue gas outlet (40) and condensate drain (70) are located in a lower section; and said drain (70) being located at the lowest point of said rhomboid shaped unit (1).

5. The system according to claim 3, wherein said condensate drain (70) is located at a distance from said flue gas outlet (40) which is equal to or larger than the diameter of said outlet (40).

6. The system according to claim 1, further comprising a fan (80) positioned in a flue gas duct down-stream of the flue gas outlet (40).

7. The system according to claim 1, wherein at last one plate or baffle is arranged in the flow path of the flue gas after entering the unit (1) through the inlet (20) and before entering the heat exchanger (10), said plate or baffle distributing the flue gas evenly over the heat exchanger (10).

8. The system according to claim 1, wherein the heat exchanger (10) is connected to a heat pump (300) which supplies a cooling medium to said heat exchanger and collects heat from the flue gas and delivers said heat to a secondary heat consumer (200).

9. The system according to claim 1, wherein said heat pump and heat exchanger are adapted to cool the flue gas to a temperature of 40° C. or below.

10. The system according to claim 9, wherein the flue gas is cooled to a temperature of 30° C. or below, preferably 20° C. or below, and most preferably during a single pass through the heat exchanger.

11. The system according to claim 1, wherein said combined heat recovery and flue gas cleaning unit (1) comprises at least two heat exchangers connected in series (10, 11).

12. The system according to claim 1, wherein said system comprises at least two combined heat recovery and flue gas cleaning units (4′, 4″) connected in parallel.

13. The system according to claim 1, adapted for integration with a boiler (100), preferably a boiler operating on a fuel chosen from natural gas, biogas, diesel, pellets, wood chips, biofuel, forest residue, lignocellulosic waste, recycled construction material and recycled wood, fuel crops, agriculture residue, forestry residue and mixtures thereof.

14. The system according to claim 1, assembled in a mobile module, preferably a shipping container.

15. A method for operating a system for simultaneous heat recovery and flue gas cleaning according to claim 1 in a heating arrangement comprising a boiler, a control unit, a primary circuit heated by said boiler, and a secondary circuit heated by flue gases from said boiler, a heat pump and at least one heat exchanger through which the flue gas passes, wherein said heat pump in said secondary circuit supplies cooling medium to said heat exchanger at a temperature in the interval −4 to +4° C., and said control unit measures the flow of the flue gas and the temperature of the cooling medium, controlling the operation of said system to maintain an input temperature of the cooling medium in the interval of −4 to +4° C. when flue gas flow rate above a pre-set value is detected, and wherein said control unit interrupts the flow of cooling media or allows the temperature of cooling media to raise to above 0° C. when the flow rate is below said pre-set value.

16. The method according to claim 15, wherein the operation of said secondary circuit, heat pump and heat exchanger is controlled to maintain an exit temperature of the flue gas of less than 40° C., preferably less than 30° C., most preferably 20° C. or less.

17. The method according to claim 15, wherein the flow and temperature of the flue gas is measured, and the operation of said secondary circuit, heat pump and heat exchanger is controlled to remove substantially all or at least a significant portion of the particulate matter from the flue gas, concentrating said particulate matter in the condensate.

18. The method according to claim 15, wherein said secondary circuit supplies heat to an external consumer, for example a fan coil unit, a convector heater, a radiator, a building dryer.

19. The method according to claim 15, wherein said boiler operates on a carbonaceous fuel chosen from biogas, natural gas, diesel, pellets, wood chips, biofuel, forest residue, lignocellulosic waste, recycled construction material and recycled wood, fuel crops, agriculture residue, forestry residue and mixtures thereof.
